(19) United States
(12) Patent Application Publication
(10) Pub. No.: US 2026/0133766 A1
(43) Pub. Date: May 14, 2026

(54) INTEGRATED GUI DESIGN METHOD AND SYSTEM

(71) Applicant: Microchip Technology Incorporated, Chandler, AZ (US)

(72) Inventors: Bill Li, Chandler, AZ (US); Ryan Rogerson, Chandler, AZ (US); Drew Davis, Chandler, AZ (US); Mohit Mohan, Chennai (IN); Eduardo Gallofin, Gilbert, AZ (US)

(73) Assignee: Microchip Technology Incorporated, Chandler, AZ (US)

(21) Appl. No.: 19/072,157

(22) Filed: Mar. 6, 2025

(30) Foreign Application Priority Data
Nov. 14, 2024 (IN) 202411088243

(51) Int. Cl. G06F 8/20; G06F 8/38; G06F 11/3698

(52) U.S. Cl. CPC G06F 8/20; G06F 8/38; G06F 11/3698

(57) ABSTRACT

A computer-implemented system for creating a graphical user interface (GUI) for an embedded hardware platform is provided. The system may include a design importer to import a structured data file representing a vector-based design, parse the structured data file into graphical elements, and render the graphical elements in a no-code visual interface, the no-code visual interface to allow codeless interaction and modification of the imported graphical elements, and a code generator to generate source code in a programming language based on the modified graphical elements and provide the generated source code to one or more simulators for testing functionality of the GUI.

### CROSS REFERENCE TO RELATED APPLICATIONS

The present application claims priority to Indian Provisional Patent Application No. 202411088243, entitled: Integrated GUI Design Method and System, filed on Nov. 14, 2024, the contents of which are hereby incorporated by reference in their entirety.

### TECHNICAL FIELD

The present disclosure relates generally to the field of graphical user interfaces (GUIs) and more specifically to an integrated GUI design workflow.

### SUMMARY

According to an aspect of one or more examples, there is provided a computer-implemented system for creating a graphical user interface (GUI) for an embedded hardware platform. The system may include a design importer to import a structured data file representing a vector-based design, parse the structured data file into graphical elements, and render the graphical elements in a no-code visual interface, the no-code visual interface to allow codeless interaction and modification of the imported graphical elements, and a code generator to generate source code in a programming language based on the modified graphical elements and provide the generated source code to one or more simulators for testing functionality of the GUI. The structured data file may be generated by an exporter plugin in a vector-based software application that converts vector-based design files into structured data files. The vector-based software application may be Figma or Adobe Photoshop. The structured data file may be a JavaScript Object Notation (JSON) file. The programming language may be C, Python, JavaScript, or Java. The one or more simulators may include a web-based simulator to perform a HTML-based web simulation, the web-based simulator including a compiler to receive the source code and compile it to a WebAssembly module using a toolchain, a WebAssembly execution environment in a web browser to interpret the compiled WebAssembly module, an HTML5 Canvas element to render components of the GUI and visual output of the simulation, and JavaScript code to manage interactions and serve as a bridge for calling WebAssembly functions generated from the source code to perform rendering operations on the Canvas element. The web-based simulator may enable testing of animations, touch interactions, and layout functionality within the GUI. The compilation of the source code to WebAssembly may occur manually or through an automated process. The one or more simulators may include a desktop-based simulator to perform a desktop-based emulation, the desktop-based simulator including a compiler to receive the source code and compile it to a machine code binary file format compatible with the embedded hardware platform, an emulator to simulate a hardware environment that closely matches the embedded hardware platform, and a debugging environment to allow embedded engineers to set breakpoints, step through code, view memory and register values, and observe real-time changes in performance of the GUI. The desktop-based simulator may directly deploy the machine code binary file to the embedded hardware platform for execution.

According to an aspect of one or more examples, there is provided a computer-implemented method for creating a graphical user interface (GUI) for an embedded hardware platform. The method may include importing a structured data file derived from a vector-based design into a no-code visual interface, displaying and enabling codeless modifications to the imported design with the no-code visual interface, generating source code in a programming language based on the modified design, and providing the generated source code to one or more simulators for testing functionality of the GUI. The structured data file may be generated by an exporter plugin in a vector-based software application that converts vector-based design files into structured data files. The vector-based application may be Figma or Adobe Photoshop. The method may also include compressing the structured data file before importing it into the no-code visual interface to reduce file size. The structured data file may be a JavaScript Object Notation (JSON) file. The programming language may be C, Python, JavaScript, or Java. The one or more simulators may include a web-based simulator to perform a HTML-based web simulation, the web-based simulator including a compiler to receive the source code and compile it to a WebAssembly module using a toolchain, a WebAssembly execution environment in a web browser to interpret the compiled WebAssembly module, an HTML5 Canvas element to render components of the GUI and visual output of the simulation, and a JavaScript code to manage interactions and serve as a bridge for calling WebAssembly functions generated from the source code to perform rendering operations on the Canvas element. The one or more simulators may include a desktop-based simulator to perform a desktop-based emulation, the desktop-based simulator including a compiler to receive the source code and compile it to a machine code binary file format compatible with the embedded hardware platform, an emulator to simulate a hardware environment that closely matches the embedded hardware platform, and a debugging environment to allow embedded engineers to set breakpoints, step through code, view memory and register values, and observe real-time changes in performance of the GUI. The desktop-based simulator may directly deploy the machine code binary file to the embedded hardware platform for execution.

According to an aspect of one or more examples, there is provided a non-transitory computer-readable storage medium storing instructions that, when executed by a processor, cause the processor to perform a method for creating a graphical user interface (GUI). The method may include importing a structured data file representing a vector-based design into a no-code visual interface, enabling codeless modifications to the design via the no-code visual interface, generating source code in a programming language based on the modified design, and providing the generated source code to one or more simulators for testing functionality of the GUI.

### BRIEF DESCRIPTION OF DRAWINGS

FIG. 1 shows a computer-implemented system for creating a graphical user interface (GUI) for an embedded hardware platform according to one or more examples.

FIG. 2 shows a flow chart of a computer-implemented method for creating a graphical user interface (GUI) for an embedded hardware platform according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

In modern software development, the design and functionality of a graphical user interface (GUI) may be important to the success of a product. Typically, the creation of a GUI may involve two distinct processes: UI/UX design, which focuses on the visual, aesthetic, and user-friendly aspects of the interface, and implementation, which implements these designs into functional software. This division may lead to inefficiencies. Design and implementation may occur in parallel but separate workflows, which may lead to a lack of synchronization and discrepancies between the intended design and the final implementation. As a result, development cycles may be prolonged, with multiple iterations required to align design with functional requirements.

The separation of these processes may necessitate extensive back-and-forth between design and implementation, often resulting in duplicated efforts, increased costs, and delayed timelines. For example, initial design concepts may need to be adjusted to align with technical restraints after implementation has already begun, while the implementation process may have to rework code to better match evolving design specifications. Therefore, there may exist a need for a more integrated workflow that can reduce redundancies, minimize the potential for errors, and accelerate the development process.

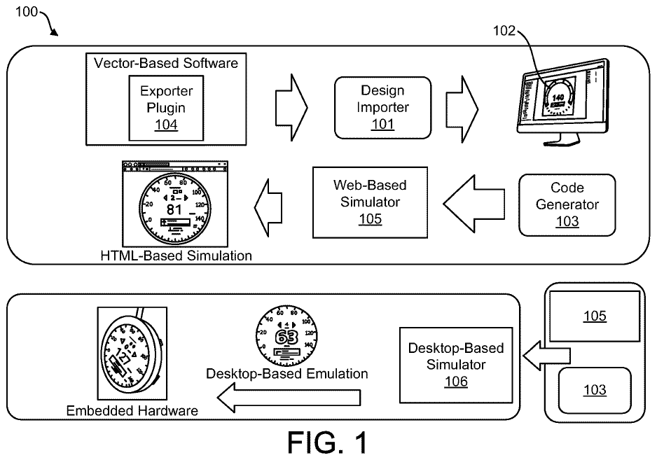

FIG. 1 shows a workflow of a computer-implemented system 100 for creating a graphical user interface (GUI) on an embedded hardware platform, according to one or more examples. As shown in FIG. 1, the system 100 may include a design importer 101, a no-code visual interface 102, and a code generator 103. The system 100 may also include an exporter plugin 104 in a vector-based software, a web-based simulator 105, and a desktop-based simulator 106.

A vector-based design may be created in the vector-based software application. The vector-based design may include static elements and dynamic elements. Static elements may be components that remain unchanged regardless of user interaction or other conditions. Static elements may provide a stable structure and layout for the interface, and help users navigate and understand the application. For example, static elements may include, without limitation, labels, icons, background images or colors, static text, borders and dividers, logos and branding, headers and footers, decorative elements, static menus or navigation bars, and non-interactive images or diagrams. Dynamic elements may be components that can change, update, or interact with users in real-time or based on specific conditions. Dynamic elements may enhance the usability and responsiveness of applications by reacting to user actions or other input. For example, dynamic elements may include, without limitation, buttons with visual feedback, interactive forms and fields, sliders and progress bars, notifications and pop-ups, expandable and collapsible sections, data visualizations, animated transitions, dynamic lists and tables, responsive layouts, and tooltips and help text.

According to one or more examples, the vector-based software application may be Figma or Adobe Photoshop. The vector-based software application may be any other application that designers use for UI/UX design, (e.g., Sketch, Axure RP, Adobe XD, InVision Studio, Framer, Marvel, ProtoPie, Balsamiq, Principle, UXPin, Adobe Illustrator, Canva, Miro, FlowMapp, Justinmind, without limitation).

The exporter plugin 104 may convert vector-based files (e.g., Figma or Photoshop files) into JSON (JavaScript Object Notation) files by extracting vector graphics data from the vector-based software application and structuring it into a JSON format, which is a text-based format for storing and exchanging data that is both human-readable and machine-readable. The exporter plugin 104 may read the vector-based file and parse its content. The exporter plugin 104 may identify elements like paths, shapes, colors, layers, fonts, and other graphical properties. Once parsed, the exporter plugin 104 may extract data for each vector element, converting properties like coordinates, paths, fill colors, and stroke information into a structured format. This operation may also involve translating complex vector paths into simpler forms that are compatible with JSON structure. For example, Bezier curve points, line segments, and commands (e.g., “move to,” “line to”) may be broken into an array of points and commands. Shapes like rectangles, circles, and polygons may be represented with their defining properties (e.g., radius for circles, width/height for rectangles). Layer information, including ordering, visibility, and naming, may be captured to help reconstruct the original design. The exporter plugin 104 may organize the extracted data into a JSON structure, based on a hierarchy that represents the layer structure and grouping within the original vector file. Each element (shape, text, image, or group) may be represented as an object within an array or nested object structure. Additional data, like metadata about the canvas size, background color, or document metadata, may also be included. After the data is extracted and organized, the exporter plugin 104 may convert the internal representation into JSON format, following JSON standards for readability. This JSON file may then be exported or saved, making it usable by other applications or tools that receive JSON input. The exporter plugin 104 may also compress the JSON file to reduce file size.

The design importer 101 may import the JSON file into the no-code visual interface 102. The design importer 101 may follow a series of steps to read, parse, and translate the JSON data into the no-code visual interface's 102 internal format. The design importer 101 may start by providing a file selection dialog, allowing users to browse and select the JSON file they want to import. After retrieving the file, the design importer 101 may verify it, checking for correct format, size limits, or JSON structure to ensure compatibility with the no-code visual interface 102. Once the file is selected or fetched, the design importer 101 may read the JSON contents directly or by processing the response if fetched over a network. The design importer 101 may parse the JSON content, converting it from a raw string of data into a data structure that the no-code visual interface 102 can process. The design importer 101 may check if the JSON data conforms to an expected structure. For example, if the JSON file should contain a list of objects with specific fields (e.g., “type,” “coordinates,” “fill,” etc.) the design importer 101 may verify that these are present. If data is missing or incorrectly formatted, the design importer 101 may provide a notification to correct the file, or provide a fallback. The design importer 101 may map JSON fields to the no-code visual interface's 102 internal structure. For example, JSON objects that represent shapes or paths may be mapped to vector elements in the application, using properties like coordinates, fill, stroke, etc. If the JSON includes layers or grouping information, the design importer 101 may arrange these elements accordingly, reconstructing the hierarchy in the no-code visual interface 102. Attributes like color, stroke width, font size, and transformations may be assigned to the no-code visual interface's 102 drawing or design properties. After mapping the JSON data, the design importer 101 may render the elements in the no-code visual interface 102, displaying the vector graphics, shapes, or other elements as specified by the JSON. If the JSON includes hierarchical or layer data, the design importer 101 may organize the visual elements into layers or groups, maintaining the structure from the original file. Any elements that could not be parsed or displayed correctly may be logged, allowing the user to troubleshoot. The imported JSON data may be saved in the no-code visual interface's 102 native file format, allowing users to continue editing without re-importing. Alternatively, if no conversion is needed, the JSON data may be saved in the no-code visual interface's 102 session, available until the user saves, exports, or closes the file. For example, to import a JSON file representing a complex vector-based design, the design importer 101 may read the JSON file and parse each JSON object into shapes with properties like path, fill, stroke, and layer order. The design importer 101 may then translate these shapes into the no-code visual interface's 102 vector graphic elements, organizing them into layers. Finally, the design importer 101 may display the design on the canvas, allowing the user to interact with each part as if it were natively created within the no-code visual interface 102.

After importing the JSON file, the no-code visual interface 102 may receive a codeless user input to modify the design. For example, once the vector-based design imported from JSON is displayed on the canvas, users can interact with each part of the design by utilizing various interactive features provided by the no-code visual interface 102. Users can interact and manipulate individual parts of the design by selection and manipulation of individual elements, layer and group management, editing attributes and properties, applying transformations, adding effects and adjustments, interacting via keyboard shortcuts, undo/redo and history, snapping and alignment tools, anchoring and constraints, saving and exporting the edited design, without limitation. In the no-code visual interface 102, users can visually edit and adjust the GUI design without needing programming knowledge. This approach may make the GUI design more accessible to non-developers, such as UI/UX designers, who can use a drag-and-drop or visual editing approach to modify the GUI directly based on the imported JSON data. The design process, which may include UI/UX designers, can work with visual tools, while the implementation process, which may include developers or embedded engineers, can later convert the JSON to code as needed, making the workflow more efficient and collaborative. The no-code visual interface 102 may allow UI/UX designers to make changes to the GUI without writing code, which may accelerate the development process and reduce dependency on developers for design updates.

The code generator 103 may generate source code based on the modified design. The code generator 103 may enable the no-code visual interface 102 to output the design as C source code that can then be used in embedded systems or other applications that render graphics using C. The code generator 103 may further enable the no-code visual interface 102 to output the design in other source code programming languages, such as Python, JavaScript, or Java, thereby providing flexibility for use across various platforms and application environments. The code generator 103 may convert visual elements into programmable data, allowing the design to be embedded directly into C-based software projects. The code generator 103 may convert vector graphics or other GUI elements into C-compatible data structures and rendering instructions. The code generator 103 may begin by reading the graphical elements (such as shapes, paths, colors, layers, and text) from the canvas. Each graphical element's properties may be extracted, including coordinates, fill/stroke colors, transformations, and any text data, to understand how to represent them in C. The code generator 103 may convert each element into a C data structure that can represent it. For example, shapes might by represented as arrays or vertices or points, and paths could be described as sequences of commands (like move, line, curve) with associated coordinates. Colors may be represented as RIB or GRAB values, with fill and stroke information stored as variables. Text strings may be converted into C strings, with properties like font size and position stored in associated variables. The code generator 103 may generate C functions or macros that represent how to render these shapes. Depending on the target environment, the drawing functions may use different libraries or APIs. The code generator 103 may create a main rendering function that combines all individual drawing functions for each element, arranging them according to their original layer order. This function may serve as the entry point, containing the full sequence of draw commands to reproduce the graphic in C. Any transformations (like rotations or scaling) may be converted to matrix transformations or similar instructions in C. Metadata, such as layer order or element visibility, may be preserved by structuring the function calls in the right sequence. The final C code may be output as a source file (.c) containing C data structures for each graphical element, drawing functions for each shape or element type, and the main rendering function to draw the full design. The exported file may be ready to be compiled and linked with other parts of a C project, such as a UI application or embedded firmware. Similarly, the final code may be output as a source file in other programming languages, such as Python, JavaScript, or Java, containing equivalent data structures for each graphical element, drawing functions for each shape or element type, and a main rendering function to draw the full design. The exported file may be ready for integration with other components of a project in the selected language, such as a web application, desktop software, or embedded system firmware.

A web-based simulator 105 and a desktop-based simulator 106 (e.g., MPLAB-X) may receive and process the C source code generated by the code generator 103 to perform their respective simulations and emulations. The web-based simulator 105 may not be able to run raw C code directly in the browser, as browsers typically do not natively support C. Instead, the C code may be compiled to WebAssembly (Wasm), which is a binary format that browsers can execute. The C source code may be compiled with a toolchain (like Emscripten), which converts the C code to a WebAssembly module. This compilation may occur locally on a developer's machine or through an automated build process. Once compiled to WebAssembly, the resulting .wasm file may be loaded by the web-based simulator 105. An HTML5 Canvas element may be used to render the GUI components and any visual output of the simulation. JavaScript and WebAssembly may be used together to manage interactions and to interpret the WebAssembly module in the browser. JavaScript may act as a bridge, calling the WebAssembly functions generated from the C source code to perform rendering operations on the Canvas element. The WebAssembly module may interpret the logic of the GUI components based on the C code, updating the Canvas in real-time or in response to user input. This approach may enable the C code logic (now in WebAssembly) to run efficiently in the browser, simulating how the GUI design would function. The HTML interface may allow users to interact with the simulation, testing animations, touch interactions, and layout functionality. Stakeholders may access this web-based simulation from any browser, making it easy to gather feedback or demonstrate the interface early in development.

The desktop-based simulator 106 may directly compile the C source code using a compatible compiler (e.g., XC8, XC16, or XC32) to produce a binary file (e.g., .hex or .elf) that represents machine code. This compilation step may ensure that the code is executable on a simulated processor environment provided by MPLAB-X. MPLAB-X may include a software simulator and hardware emulation tools that replicate the microcontroller's architecture and functionality, including memory, registers, timers, and other peripherals. The emulator may run the compiled binary file, simulating the hardware environment where the GUI code will eventually execute. This may include accurate timing, interrupt handling, and memory usage, providing a realistic environment that closely matches the actual hardware. During the emulation, MPLAB-X may allow embedded engineers to set breakpoints, step through code, view memory and register values, and observe real-time changes in the GUI's performance. This debugging capability may be used for detecting and fixing issues that may arise due to hardware constraints like memory limitations or processor speed. Embedded engineers may improve the GUI's performance on the desktop-based emulator before deploying it to the actual hardware. After testing and debugging are completed on the emulator, the same compiled binary file may be directly deployed to the embedded hardware platform. The desktop-based emulation may verify that the code behaves as expected, reducing the likelihood of issues when deployed to the actual device.

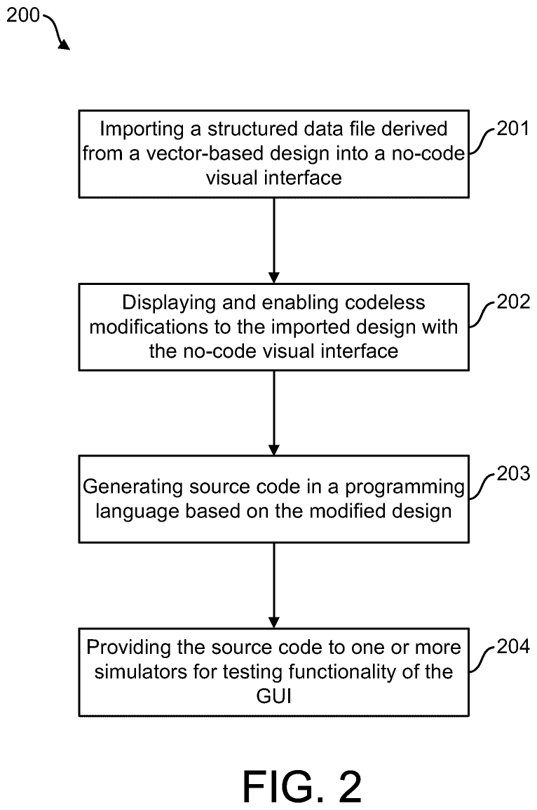

FIG. 2 shows a flow chart of a computer-implemented method 200 for creating a graphical user interface (GUI) on an embedded hardware platform, according to one or more examples. As shown in FIG. 2, the method 200 may include importing 201 a structured data file derived from a vector-based design into a no-code visual interface. The method 200 may include displaying and enabling 202 codeless modifications to the imported design with the no-code visual interface. The method 200 may include generating 203 source code in a programming language based on the modified design. The method 200 may include providing 204 the source code to one or more simulators for testing functionality of the GUI.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A computer-implemented system for creating a graphical user interface (GUI) for an embedded hardware platform, comprising:
a design importer to import a structured data file representing a vector-based design, parse the structured data file into graphical elements, and render the graphical elements in a no-code visual interface, the no-code visual interface to allow codeless interaction and modification of the imported graphical elements; and
a code generator to generate source code in a programming language based on the modified graphical elements and provide the generated source code to one or more simulators for testing functionality of the GUI.

2. The system of claim 1, wherein the structured data file is generated by an exporter plugin in a vector-based software application that converts vector-based design files into structured data files.

3. The system of claim 2, wherein the vector-based software application is Figma or Adobe Photoshop.

4. The system of claim 1, wherein the structured data file is a JavaScript Object Notation (JSON) file.

5. The system of claim 1, wherein the programming language is C, Python, JavaScript, or Java.

6. The system of claim 1, wherein the one or more simulators include:
a web-based simulator to perform a HTML-based web simulation, the web-based simulator comprising:
a compiler to receive the source code and compile it to a WebAssembly module using a toolchain;
a WebAssembly execution environment in a web browser to interpret the compiled WebAssembly module;
an HTML5 Canvas element to render components of the GUI and visual output of the simulation; and
JavaScript code to manage interactions and serve as a bridge for calling WebAssembly functions generated from the source code to perform rendering operations on the Canvas element.

7. The system of claim 6, wherein the web-based simulator enables testing of animations, touch interactions, and layout functionality within the GUI.

8. The system of claim 6, wherein the compilation of the source code to WebAssembly occurs manually or through an automated process.

9. The system of claim 1, wherein the one or more simulators include:
a desktop-based simulator to perform a desktop-based emulation, the desktop-based simulator comprising:
a compiler to receive the source code and compile it to a machine code binary file format compatible with the embedded hardware platform;
an emulator to simulate a hardware environment that closely matches the embedded hardware platform; and
a debugging environment to allow embedded engineers to set breakpoints, step through code, view memory and register values, and observe real-time changes in performance of the GUI.

10. The system of claim 9, wherein the desktop-based simulator is to directly deploy the machine code binary file to the embedded hardware platform for execution.

11. A computer-implemented method for creating a graphical user interface (GUI) for an embedded hardware platform, comprising:
importing a structured data file derived from a vector-based design into a no-code visual interface;
displaying and enabling codeless modifications to the imported design with the no-code visual interface;
generating source code in a programming language based on the modified design; and
providing the generated source code to one or more simulators for testing functionality of the GUI.

12. The method of claim 11, wherein the structured data file is generated by an exporter plugin in a vector-based software application that converts vector-based design files into structured data files.

13. The method of claim 12, wherein the vector-based application is Figma or Adobe Photoshop.

14. The method of claim 11, further comprising compressing the structured data file before importing it into the no-code visual interface to reduce file size.

15. The method of claim 11, wherein the structured data file is a JavaScript Object Notation (JSON) file.

16. The method of claim 11, wherein the programming language is C, Python, JavaScript, or Java.

17. The method of claim 11, wherein the one or more simulators include:
a web-based simulator to perform a HTML-based web simulation, the web-based simulator comprising:
a compiler to receive the source code and compile it to a WebAssembly module using a toolchain;
a WebAssembly execution environment in a web browser to interpret the compiled WebAssembly module;
an HTML5 Canvas element to render components of the GUI and visual output of the simulation; and
a JavaScript code to manage interactions and serve as a bridge for calling WebAssembly functions generated from the source code to perform rendering operations on the Canvas element.

18. The method of claim 11, wherein the one or more simulators include:
a desktop-based simulator to perform a desktop-based emulation, the desktop-based simulator comprising:
a compiler to receive the source code and compile it to a machine code binary file format compatible with the embedded hardware platform;
an emulator to simulate a hardware environment that closely matches the embedded hardware platform; and
a debugging environment to allow embedded engineers to set breakpoints, step through code, view memory and register values, and observe real-time changes in performance of the GUI.

19. The method of claim 18, wherein the desktop-based simulator is to directly deploy the machine code binary file to the embedded hardware platform for execution.

20. A non-transitory computer-readable storage medium storing instructions that, when executed by a processor, cause the processor to perform a method for creating a graphical user interface (GUI), the method comprising:
importing a structured data file representing a vector-based design into a no-code visual interface;
enabling codeless modifications to the design via the no-code visual interface;
generating source code in a programming language based on the modified design; and
providing the generated source code to one or more simulators for testing functionality of the GUI.
